(19) United States
(12) Patent Application Publication
(10) Pub. No.: US 2007/0273277 A1
(43) Pub. Date: Nov. 29, 2007

(54) More Uniform Electroluminescent Displays

(75) Inventors: Christopher James Newton Fryer, Cambridgeshire (GB); Richard Guy Blakesley, Cambridge (GB); Christopher John Andrew Barnardo, Herfordshire (GB); William Frank Tyldesley, Cambridge (GB); Michael A. Powell, London (GB); Andrew Green, Cambridge (GB)

Correspondence Address: SUTHERLAND ASBILL & BRENNAN LLP, 999 PEACHTREE STREET, N.E., ATLANTA, GA, 30309, US

(73) Assignee: PELIKON LIMITED, Cambridge (GB)

(21) Appl. No.: 10/567,246

(22) PCT Filed: Aug. 9, 2004
(86) PCT No.: PCT/GB04/03419

§ 371 Date: Apr. 10, 2007

(30) Foreign Application Priority Data
Aug. 7, 2003 (GB) 0318598.0
Aug. 22, 2003 (GB) 0319838.9
Apr. 2, 2004 (GB) 0407601.4
Jun. 18, 2004 (GB) 0413717.0

(51) Int. Cl. H01J 1/62

(52) U.S. Cl. 313/506

(57) ABSTRACT

Certain materials are electroluminescent, and this electroluminescent effect has been used in the construction of backlights for displays. Such a backlight commonly consists of a transparent front layer (11) known as the substrate carrying its rear face a transparent electrically-conductive film (12) forming the backlight's front electrode and covered by a layer of electro-luminescent/phosphor material (13) over the rear face of which is a high-dielectric layer (16) bearing on its rear face a conductive film (17) forming the back electrode. The whole is positioned behind a mask (18) that defines whatever characters the display is to show. This use of a mask has some disadvantages, some of which can be overcome by utilising an array of suitably shaped individual electrodes (21) instead of a continuous one, and by shaping the electroluminescent material itself in discrete areas (43) each tightly matching in shape and size the relevant individual shaped back electrode (21). This latter, however, itself has drawbacks, for the colour of the phosphor commonly contrast with the colour of the surrounding insulating material, so that the discrete areas of phosphor may be visible under ambient light even when in their inactivated, “off”, state. The invention deals with this problem by proposing that there be modified—or apparently modified—the colour/reflectivity of one or other (or, indeed, both) of the phosphor (43) and the surrounding insulator material (16) so as to 2match” that of the other, and thus cause the phosphor and insulator material to blend with, and so be less distinguishable from, each other.

This invention is concerned with electroluminescent (EL) displays, and relates in particular to improving the uniformity and visibility of such displays.

Certain materials are electroluminescent—that is, they emit light, and so glow, when an electric field is generated across them. The first known electroluminescent materials were inorganic particulate substances such as zinc sulphide, while more recently-found electroluminescent materials include a number of small-molecule organic emitters known as organic LEDs (OLEDs) and some plastics—synthetic organic polymeric substances—known as light-emitting polymers (LEPs). Inorganic particulates, in a doped and encapsulated form, are still in use, particularly when mixed into a binder and applied to a substrate surface as a relatively thick layer; LEPs can be used both as particulate materials in a binder matrix or, with some advantages, on their own as a relatively thin continuous film.

This electroluminescent effect has been used in the construction of displays, in which a large area of an electroluminescent material—generally referred to in this context as a phosphor—is provided to form a backlight which can be seen through a mask that defines whatever characters the display is to show.

Such a backlight commonly consists of, from front (the side from which it is to be viewed) to back:

a relatively thick protective electrically-insulating transparent front layer known as the substrate and made usually of a glass or a plastic such as polyethylene terephthalate (PET);

over the entire rear face of the substrate, a very thin transparent electrically-conductive film made from a material such as indium tin oxide (ITO), this forming one electrode—the front electrode—of the backlight;

covering the rear face of the front electrode, a relatively thin layer of electroluminescent/phosphor material (usually a particulate phosphor within a binder matrix);

over the rear face of the phosphor layer, a relatively thin electrically-insulating layer of a material—usually a ceramic—having a relatively high dielectric constant (relative permittivity) of around 50;

covering the entire rear face of the electrically-insulating layer, a continuous electrically-conductive film, usually opaque (and typically carbon or silver), forming the other electrode—the back electrode—of the backlight.

In addition, the back electrode layer, which is quite delicate, is covered with a protective film (usually another, similar, ceramic layer) to prevent the layer being damaged by contact with whatever device components—electronic circuitry, for example—might be mounted behind the display.

Each of the various layers is conveniently screen-printed into place (apart from the ITO front electrode, which is usually sputtered onto the substrate) in the normal way, through masks that define the shape, size and position of the layer components, using suitable pastes that are subsequently dried, set or cured, commonly by heat or ultraviolet light, as appropriate, prior to the next layer being applied. And in the context of electroluminescent displays, the expressions “relatively thick” and “relatively thin” mean thicknesses in the ranges, respectively, of 30 to 300 micrometres, usually around 100 micrometres, and less that 50 micrometres, and most usually 25 micrometres or less.

In a display, such a backlight is positioned behind a mask that defines whatever characters the display is to show. Unfortunately, to form a truly effective, easy-to-read display the background uniformity of the display must be well controlled so as not to distract the eye of the Viewer from the information that it is intended to reveal. To date this has not satisfactorily been achieved for electroluminescent displays.

As intimated above, the majority of electroluminescent displays exploit the uniform illumination properties of the electroluminescent principle as a backlight, enabling graphics characters to be formed through the use of cut out overlays that allow the light to shine through specific apertures. Characters formed in this way using particulate phosphors tend to be less than sharp. Moreover, such a display is an “all or nothing” display; when the backlight is “on”, all the characters are illuminated, while when it is “off” none of them are.

It was then realised, however, that much clearer, crisper displays, with individually-activatable characters, could be constructed by “reversing” the normal structure of backlight with masking overlays. More specifically, it was found that if the phosphor layer were associated on at least one side (and particularly at the rear) with an array of individual appropriately-shaped electrodes instead of a continuous electrode then the mask could be done away with completely, for the phosphor could be inherently activatable in the forms of the discrete shapes desired—for example, an ikon, an alphanumeric character, or a pattern of independently-switchable segments that by their arrangement provide reconfigurable information—so there could be made a display that had the desired sharpness.

The thus-formed displays were indeed a considerable advantage over the previous, mask-utilising, ones, but they still suffered from a number of drawbacks. One such arose directly from the use of individual appropriately-shaped back electrodes instead of a continuous electrode; whereas with a continuous back electrode extending effectively from edge to edge of the display an activating voltage could be supplied by a lead to a contact at the very edge of the display, which could easily be hidden from sight, individual back electrodes required leads, formed as conductive tracks laid onto the dielectric layer carrying the electrodes, some of which track leads necessarily crossed over the main area of the display. And since each track lead, even though extremely narrow, acted as an electrode in its own right, the phosphor was activated not only by each individual shaped electrode but also by the lead to that electrode, giving rise to a faint, but distracting (and possibly confusing), additional source of illumination, making each ikon or character of the display look as though it had a tail.

Various attempts have been made to deal with this problem, and one of the more successful to date is not to form the lead tracks directly on the dielectric layer carrying the back electrodes, as is usual, but instead to space the tracks further from the electroluminescent material layer by placing an additional insulating layer, between the tracks and the dielectric layer carrying the electrodes, so as to reduce the field produced by the tracks, and so minimize the unwanted activation and illumination effect of the underlying phosphor. However, each track lead still acts as an electrode, and so still gives rise to a faint, albeit now much fainter, source of illumination, so that each ikon or character of the display still looks as though it has a tail.

This problem of track-derived tails is addressed by the invention of our copending British Patent Application Number 0318598.0 In that appication, it is proposed that the electroluminescent material itself be formed into discrete areas each tightly matching in shape and size the relevant individual shaped back electrode. This works well, but has an unfortunate side effect: although a display made using a shaped-area back electrode and a correspondingly shaped-area phosphor layer is sharp and crisp, and does away with the requirement for an image-defining mask, the thus-formed display may suffer from a number of drawbacks, one of which derives from the very “removal” of the mask and the concomitant shaping of the electroluminescent material. The problem is that even when the electroluminescent material—the phosphor—is not activated, and so is not emitting light, it can itself be seen, albeit only dimly, by reflected light—by light passing into the display from the ambient surroundings and then being reflected back out off the various display components. This is aggravated by the fact that the material “surrounding” the display's phosphor shapes, namely the insulating layer (usually a ceramic) is of a different colour, and a different reflectivity, to that of the phosphor layer, so emphasising the visibility of the phosphor shapes even when unactivated.

The present invention suggests a simple solution to this, which is to modify—or apparently to modify—the colour/reflectivity of one or other (or, indeed, both) of the phosphor and the surrounding insulator material so as to “match” that of the other, and thus cause the phosphor and insulator material to blend with, and so be less distinguishable from, each other.

In one aspect, therefore, this invention provides an electroluminescent display of the type wherein a layer of electroluminescent material is sandwiched between but spaced from two electrode layers, and the electroluminescent material is composed of a plurality of separate areas each matching in shape and size the image which the relevant portion of the display is to show, each such area being surrounded by a layer of insulating material,

in which display the colour/reflectivity of one and/or other of the electroluminescent material and the surrounding insulator material is modified—or is apparently modified—so as to match that of the other.

The invention provides an electroluminescent display for some sort of device. This device can be of any shape and form, and for any purpose. A typical example of such a device is a hand-holdable controller—a remote control—for a radio, an audio cassette tape deck, a CD player, a television, a DVD player or a video recorder, and for such a use the device will normally have an oblong panel, perhaps 13×5 cm (5×2 in), on which are positioned a plurality of individual display elements appropriate to the device's purpose. Thus, for instance, for a tape deck the display elements might be ikons (or words, or the individual letters of words) that represent (amongst other possibilities) “play”, “fast forward”, “fast reverse”, “record”, and “stop”.

The display of the invention is an electroluminescent display—that is, it is a display which uses electroluminescence to light up its several parts. More specifically, it is such a display utilising layers of a particulate electroluminescent material—a particulate phosphor—rather than continuous sheets or films of electroluminescent material. The particulate phosphor can be a light-emitting plastic (LEP) in particulate form, but most preferably it is an inorganic material; a typical inorganic particulate phosphor is zinc sulphide, especially in the form of encapsulated particles (encapsulation provides substantially-increased stability and life). An especially convenient such zinc sulphide is that heat-curable material available under the name 7151j Green Blue from Dupont, in a layer around 25 micrometer thick. Another such sulphide is 8164 High Bright Green, also from DuPont.

Unlike many electroluminescent displays known in the art, the invention's display has, instead of a single large area of uniformly-activatable electroluminescent material forming a “back light” to the mask-defined characters or ikons to be displayed, separately-activatable individual areas each of which represents either a whole or a part of a character or ikon to be displayed. As a result, the display appears much sharper, crisper and “cleaner” than the conventional back-panel versions.

In this display each character or ikon can be whole and complete in itself—an individual number or letter (of the alphabet), or an ikon (or symbol, pictogram, cartouche or glyph) representing some desired effect (such as the right-pointing single chevron commonly employed to mean “play”, or the similar double chevron meaning “fast forward”). However, in addition—or as an alternative—the individual areas can form small parts of a larger region which itself has some meaning or message. Thus, the small individual areas can be grouped into sets of related character-defining segments each group of which can, by the activation of the appropriate segments, define any character there to be displayed. A typical group is the standard seven-segment group commonly employed in modern electrical and electronic displays; by suitably choosing which of the segments is switched on, so the group can be made to display any Arabic numeral or Roman-alphabet character (other numbering or alphabet systems may need groups with more segments). The groups themselves can of course be disposed in an array; by manipulating each of the portions of the array so there may be presented, for example, a complete textual message.

Each activatable area comprises a thin (around 25 micrometre) layer of phosphor having on either side adjacent each face of the layer—the (front or rear) electrode which is used to provide the voltage across the layer to switch it into its electroluminescent state.

The various layers of material from which the display of the invention is constructed can be formed by the usual screen printing methods, utilising the various techniques and paste-like materials generally known for that purpose, and no more need be said about that here.

In addition, the substrate may be overlaid with an exterior protective film, which can if appropriate be coloured or bear legends of one sort or another.

The electroluminescent display, the materials of which and the manner in which it is formed, and the device of which it is a part, may be as described hereinbefore, and no more need be said about that here.

In this improved display the colour/reflectivity of one or other of the electroluminescent material—the phosphor—and the surrounding dielectric material (the ceramic/insulator) is modified so as to match—or appear to match—that of the other. This can be achieved in a number of distinct ways.

Firstly, the colour/reflectivity of the insulator material can be changed to match that of the phosphor. Thus, the insulator material to be used can be blended with suitable colouring materials—inks or dyes—to give a colour match to the “off” (unactivated) state of the phosphor, so that when the coloured insulator material is then deposited everywhere the phosphor is not—that is, around the phosphor—there is presented the impression of a continuous layer when the combination is viewed through the transparent electrode.

The commonly-employed phosphors—for instance, the particular zinc sulphide referred to above—tend in their cured but “off” state to be an off-white or cream colour, while the ceramic-like insulator materials that surround the phosphor, such as those referred to hereinbefore, tend in their cured state to be white but to appear (at least, when viewed through an ITO-coated substrate) to be beige. The colour of such an insulator can be modified to be more like that of the phosphor by incorporating into the insulator suitable amounts of an appropriate solvent-based dye selected from Dylon's “Multipurpose” range—with the same specific phosphor and insulator mentioned above, the colour of the phosphor can be modified to be more like that of the insulator by incorporating into the phosphor suitable amounts of Dylon's “reindeer beige”.

Secondly, there can be done what is effectively the opposite—the colour/reflectivity of the phosphor material can be changed to match that of the insulator. Thus, the phosphor material to be used can be blended with suitable colouring materials—inks or dyes—to give a colour match to the insulator material, so that when the insulator material is then deposited everywhere the phosphor is not—that is, around the phosphor—there is again presented the impression of a continuous layer when the combination is viewed through the transparent electrode.

With the same specific phosphor and insulator mentioned above, the colour of the phosphor can be modified to be more like that of the insulator by incorporating into the phosphor suitable amounts of an appropriate ink—in this case a white such as Sericol's Colorstar CS CS021.

Thirdly, the colour/reflectivity of each of the phosphor material and the insulating material can be modified so as more closely to match each other. Thus, the phosphor material to be used can be blended with a material of one suitable colour while the insulating material can also be blended with a material of a suitable colour—possibly a different colour, but most likely a different intensity of the same colour—so that when the insulator material is then deposited everywhere the phosphor is not—that is, around the phosphor (and, indeed, over the back of the phosphor)—there is again presented the—impression of a continuous layer when the combination is viewed through the transparent electrode.

Obviously, care should be taken that the dye (or other colouring material) chosen (for whichever component), and the amount of it that is used, does not deleteriously affect the required properties of the component—specifically the dielectric constant of the insulating material and the light-emitting capabilities of the phosphor.

A fourth possible way of achieving the desired colour/reflectivity matching of phosphor and insulator is to form between the substrate and the insulator layer an additional layer of suitably-coloured material so as effectively to mask the insulator layer from view, so again there is presented the impression of a continuous layer when the combination is viewed through the transparent electrode.

With the same specific phosphor mentioned above, the required insulator-masking layer can be formed using an ink such as Sericol's Colorstar CS CS021 (which has a matching white colour).

A fifth, and rather different, way of attaining the desired reduction in colour/reflectivity mismatch between the “off” phosphor and the insulator/dielectric material is to provide the display with a front filter/absorber layer—an overlay—of suitably-coloured transparent material so as appropriately to modify the manner in which external light entering the display from the ambient surroundings is transmitted thereinto and then reflected back. This filter layer, the use of which apparently modifies the colour/reflectivity of one or other of the electroluminescent/phosphor material and the surrounding insulator material so as to match that of the other, either can be a part of the substrate itself or, and preferably, it can be an additional layer formed on the substrate (and conveniently on the outside, front, surface).

This use of a coloured filter layer may be applied in addition to the colouring of the phosphor and/or insulating layer; indeed, such a combination of coloured phosphor and coloured filter is the preferred choice (the actual colours and intensities employed being carefully matched one to the other), with the use of a coloured insulator as well being most preferred, as described in more detail below.

The filter layer appropriately modifies how external light entering the display is then reflected back from the several interfaces—typically ambient air/filter, filter/substrate, substrate/phosphor and substrate/insulator. In this particular case what is required is that the light reflected off the very front of the display—the front of the filter—should be very much greater than the light reflected off any of the “internal” interfaces, and that the light reflected from the substrate/phosphor interface should match in colour and hue the light reflected from the substrate/insulator interface. And when the display—the phosphor—is “on” (activated), the output from the phosphor should be significantly greater than any reflected light (and especially that off the filter at the very front).

Although the filter can be positioned to be (or not to be) only at places in register with various individual images to be displayed, it can alternatively, and perhaps with advantage, cover the entire surface of the display.

It will be seen that, using such a filter, emitted light from the phosphor makes one pass through the filter while reflected light from the ambient surroundings must make two passes through the filter, and so the resultant visibility of any pattern of phosphor is, in the “off” state, reduced by the ratio of the absorbency of the filter. Of course, the overall brightness of the display is also reduced, but the ratio between the “on” state emissions and any of the various “off” state reflection levels is enhanced.

This effect can be further exploited if the reflectance spectrum of the filter is shifted in wavelength compared to the transmittance spectrum of the filter, so that the colour/hue of the emitted light from the phosphor is not the same as that of the reflected light from the very front—the filter—surface of the display. While this does not provide an improvement in light intensity terms nevertheless it improves visibility through chrominance contrast.

A suitable material colour for such a filter, providing the desired effect, is that deep blue provided by Ultramark under the designation 575/T134402.

As indicated, it is particularly preferred to colour all three components—the phosphor, the insulating layer, and the filter. Most conveniently all three colours are much the same but of different intensity—shades of blue, for example, or shades of grey—and the colours are preferably darker—more intense—the higher the intrinsic reflectivity of the component. For example, using the materials specifically identified above, the phosphor is both whiter and more reflective than the insulating layer, and so may need to be coloured darker (though, with such thin layers as these, it is likely that if the phosphor and the insulating layer are both coloured much the same, the former, upon which the latter is fabricated, will appear darker when viewed with the latter behind it. In this case, then, the coloured phosphor and insulating layer “match” each other not in the sense that when viewed directly they blend until the boundary between disappears but that when viewed through the applied filter layer they then appear to match, blending in the desired way.

Mathematically, the effects observed can be described generally by the following expressions:

In the “off” state there apply the following functions:

a) Dielectric
RJ[R₁,G₁,B₁](x)TJ[R₂,G₂,B₂]I₀J[R₃,G₃, B₃]
b) Dyed phosphor
RJ[R₄,G₄,B₄](x)TJ[R₂,G₂,B₂]I₀J[R₅,G₅, B₅]
so the eye perceives little or no “off” state clutter. In general, the hue of the incident light is irrelevant; it just changes the magnitude of I₀.

In the “on” state:

a) Dielectric
RJ[R₁,G₁,B₁](x)TJ[R₂,G₂,B₂]I₀J[R₃,G₃, B₃]
b) Dyed phosphor
R₁J[R₆,G₆,B₆](x)TJ[R₂,G₂,B₂]I₃J[R₇,G₇,B₇]

where I₃>>I_{0 and}

R₂, R₇ are small, and G₇B₇>B₃.

The described fifth way of attaining the desired reduction in colour/reflectivity mismatch between the “off” phosphor and the insulator/dielectric material is, as just discussed, to provide the display with a front filter/absorber layer—an overlay—of suitably-coloured transparent material so as appropriately to modify the manner in which external light entering the display from the ambient surroundings is transmitted thereinto and then reflected back. And so far this has been described in more detail in connection with the use of all three components having much the same colour (blue, specifically). However, it is perhaps surprisingly possible to achieve a similar effect in another, albeit related manner, which is to provide the front filter with a transparency colour that matches the light emitted by the display's lightable areas when they are “on” (for most of the preferred electroluminescent materials this is a bright green-white) but then to arrange that the phosphor and the insulating/dielectric material is coloured to have the complementary colour to this filter transmission colour.

As a result, in the each area's “off” state the light reflected from the display—from each area and from the surrounding dielectric—is a mismatch to the transmission characteristics of the filter, and so is absorbed, with the result that the display appears uniformly very dark, even black; and the individual phosphor areas cannot be distinguished. In the “on” state, of course, the emitted light matches the filter's transmissivity, and provides a bright high-contrast display.

Mathematically, the effects observed can be described generally by the following expressions:

In the “off” state there apply the following functions:

a) Dielectric
RJ[R₁,G₁,B₁](x)TJ[R₂,G₂,B₂]I₀J[R₃,G₃, B₃]
b) Dyed phosphor
RJ[R₄,G₄,B₄](x)TJ[R₂,G₂,B₂]I₀J[R₅,G₅, B₅]

where, for the case of a blue-emitting phosphor and a blue filter,

B₁-B₄<<R₁, R₄, G₁, G₄, and I₀ is much less than the intensity of the general ambient light.

In the “Ion” state:

b) Dyed phosphor
R₁J[R₅,G₅,B₅](x)TJ[R₂,G₂,B₂]I₀J[R₆,G₆, B₆]

where I₂ is approximately I₁, and >>I₀ and

B₆>>R₆,G₆.

The visibility of electroluminescent displays is dependent upon the contrast between those areas of the display that are turned on (“lit”) and those that are not; this contrast is the result of the lit areas being both brighter than the surrounding areas (“luminance contrast”) and often also a different colour (“chrominance contrast”). The brightness and colour of the lit areas is a function of the particular electroluminescent material being utilised and of the degree to which it is energised. The brightness and colour of the unlit areas is dependent on the light reflected off their surface, which in turn is a function of the ambient light level and the materials used to make up the display (which might include filters and anti-reflective coatings).

Alternatively, the present invention also proposes the use not of a coloured filter but instead of the very opposite—a neutral density filter (that is, a filter which, “grey” in appearance, filters out all colours uniformly). And in addition there is also proposed a “filter” layer which has a specularly-reflective front (exterior) surface (typically such a layer is, like a one-way mirror, semi-silvered, so as to be highly reflective from one side (the outside) but significantly transmissive from the other side (the inside).

When using such a neutral density filter or a specularly reflective filter it is possible to replace the transparent front electrode (the ITO layer) with a thin somewhat transparent metallic electrode. The attenuation of the electrode-to emitted light will be in the same range as before (i.e. about 3-20 dB). In high volume this arrangement may be less expensive than the alternate and achieve the same performance.

The use of a neutral density filter in the context of a display is believed to be independently inventive. Therefore, in a further aspect, the invention provides a light-emitting display wherein there is the necessity for a clear contrast between the display's lit and unlit areas, which display includes a transmissive overlay that forms either a substantially-neutral-density filter or an outwardly-facing specularly-reflective surface, or both.

The light-emitting display can be of any sort—it could, for instance, be a light-emitting diode (LED) display, or it could be a backlit liquid crystal display (an LCD) or even a thin film transistor (TFT) display as used in computer screens—but the invention is of particular value when applied to displays using electroluminescent materials to provide the light output.

Electroluminescent (EL) displays are valued for their flexibility and thinness, which means they can be cut to any shape, operate on curves or be laid over button mats (operating as the display flexes when the button is pushed through the display).

Making a display remain hidden until there is some necessity for it to be revealed (and so seen by the User) is desired so that the display be uniformly blank until a segment is switched on, when it becomes visible. A unique feature of EL displays is that the light emanating from a switched on segment comes, as far as an observer is concerned, right from the surface of the display. However, as observed above many existing types of EL display are not ideal, in that much of the details of the display—such as the connection tracks into the segments and other structures—are visible. As the display is surface emitting, and due to the thinness of the display, observers tend to see these “off” elements (the inactive or non-active ones), which thus have the effect of reducing the visibility of the “on” (active) segments.

To make the “on” segments more apparent it has been traditional either to increase their brightness or to operate the display in a dim environment. The latter option severely limits EL displays, as many applications are for the display to be mounted directly onto the surface of a product that may be in a bright daylight environment. Increasing the display's emitted brightness is possible, but has a severe disadvantage in that it may significantly reduce the lifetime of the display (and also run down any battery power source used to drive the display), and is in any case a losing battle for displays used in high intensity environments (where, in essence, the display is trying to outshine the ambient sunlight!). Most emissive technologies are unable to do this with acceptable reliability and lifetime.

This aspect of the present invention—which involves the use of a transmissive overlay that forms a neutral-density filter and/or an outwardly-facing specularly-reflective surface—results in both the suppression of visibility of any connecting tracks and the display's internal structure and also an improvement to the visibility of the display's “on” segments compared to background scattered ambient light from the “off” elements of the display by what seems at first to be the rather bizarre idea of actually making the display dimmer. However, it works—and this is believed to be for the following reasons.

When using a neutral-density filter, suppression of the internal display structure—elements which are either unactivatable or are activatable but “off”—is—achieved by reducing the intensity of the light reflected from such elements in comparison to the light emitted by the “on” segments. A thin, highly-absorbing, neutral layer placed over the display allows light from the emitting element to pass therethrough only once, and so is attenuated only once. However, light exiting from the structural elements and the “off” segments of the display, both of which only reflect ambient light, has passed through the absorbing layer twice. The contrast between the two lights is thus enhanced, even though the light from the “on” elements is reduced somewhat.

The visibility of the “on” elements increases—in comparison to all the other areas of the display—as the absorption of the overlay increases. This leads to the bizarre, intuition-contrary position that the brighter the environment the more absorbing the layer needs to be to achieve high visibility. The limit to how absorbing this overlay can be is determined by the point at which the light emitted by the “on” segments falls below the general background illumination of the environment in which the display is used, and so cannot be distinguished by the observer.

The display utilises a substantially-neutral-density filter. Strictly, and in theory, a true neutral-density filter is one that filters—that absorbs—all light frequencies equally. In practice, however, such perfect neutrality is not easily achieved, or achievable. Most filters commonly accepted as being neutral-density can show a difference, in some cases of as much as 20%—between the highest and low-st absorption across the range of the visible light spectrum. Thus, for the purposes of the present invention the term “neutral-density” includes such a frequency-dependent case—though it is naturally preferred that the difference be as small as possible.

Neutral-density filters vary—in appearance—from black through charcoal grey up to the very lightest grey, as the amount of light they absorb reduces. For the invention, in a real environment the absorption effect of the neutral-density filter used in the invention may conveniently be from 75 to 85%, and is most preferably around 80% (so that the emitted light is reduced to 20% of its original intensity while the reflected light is reduced to a further 20%, being a mere 4% of the ambient light level). Typical materials providing this sort of absorption together with the right degree of flexibility and thinness are CP Films AT15GR HPR and Bekaert Black type NR Charcoal 17.

A specularly-reflective layer works in a different manner. Another factor that reduces the visibility of the “on” segments is the light reflected from the top—the outer—surface of the display. This is a significant issue for a surface-emitting display, as the light from the “on” segments within the display emanates from the same (or very nearly the same) plane as reflected light from the front face of the display. By contrast, other types of display avoid this problem because they have depth—the “on” portions are clearly significantly “below” the front surface of the display—and the eye/brain combination concentrates on the plane of the emitted light from the segments, and ignores the light reflected from the front of the display (a technique similar to “pulling focus” as used in photography). Another technique for avoiding surface reflection effects is to use expensive and often brittle anti-reflection coatings. However, neither technique—“deep” light-emitting elements, and anti-reflection coatings—is appropriate for surface-emitting EL displays that typically are required to be both low cost and also flexible. This part of the invention uses the surprising step of actually increasing the reflectivity of the surface layer by using a gloss finish.

Using an overlay having a specularly-reflective surface works by directing the light in specific directions and not scattering it. Thus, the eye can image the “on” segments on the surface of the display, which then means that all other specularly-reflected light is out of focus and so has minimal effect on the display's “on” segment visibility.

If the light source that is specularly reflected is very bright even when it is not in focus, such as the sun, the “on” segments can become visible to the User simply by slightly tilting the display so the bright object is specularly reflected somewhere other than back to the User.

This implementation of the invention can be effected just by having a very smooth—a “gloss”—finish to the front surface of the display, and the two neutral-density filter materials mentioned above do indeed have a high gloss, shiny, surface, providing the required specularly-reflective effect. However, in one extreme, and preferred, case an additional coating is provided on the outer surface to give a more truly reflective material, such as a metallic finish, showing a “silvered” or “chromed” effect.

In the case where the display is viewed normal to the User, only the light reflected from his or her face and impinging on the display is reflected straight back to the User. This is usually of a much lower intensity than the advent light, but is also out of focus as apparently it is as far behind the display as the User is in front, and so has minimal effect on display visibility.

Reflective surfaces vary in the amount of light they reflect. In a real environment the reflective effect of the specularly-reflective overlay used in the invention may conveniently be from 75 to 85%, and is most preferably around 80%. Typical materials providing this sort of reflection together with the right degree of flexibility and thinness are CP Films RS20SR HPR (which is a plastics sheet with a sputtered metallised finish plus a gloss, scratch-resistant, anti-glare protective overlay.

Another example of this type of specularly-reflective material is that forming a multilayer “radiant” colour film; the use of such film is in accordance with the present invention. In addition to the specular finish, such materials—which are of a multi-layer construction where the colour results from interference fringes generated by light travelling through the layers and being at least partially reflected at the layer boundaries, and then interfering with itself so as to cancel out certain colours rather than others—also exhibit a change in transmissivity and colour for changing viewing angles. In this way, when the User slightly tilts the display so that any bright object behind the User is specularly-reflected somewhere other than back to the User, the colour of the display changes, thereby increasing the contrast between the lit and the unlit areas of the display. This significantly improves the display visibility in high ambient lighting conditions. Also, since the materials are highly transmissive when viewed straight on, the display is highly visible in low ambient lighting conditions; thus, the overall brightness can be reduced, extending lifetime and thereby increasing performance.

Typical such multilayer “radiant” colour materials are transparent 3M RADIANT Colour Film or 3M RADIANT Mirror Film, (types 3M CMSOO, 3M CM590 [3M Radiant colour films] and 3M VM2002), available from 3M (Minnesota Mining and Manufacturing).

Making a display hidden until reveal is desired so that the display is uniformly blank until a segment is switched on, and then it becomes visible.

For white finishes this is very difficult as the white color is achieved by using a material that strongly scatters light, uniformly across the entire visable spectrum. Unless the display image is projected without lateral dispersion of the image, the image will appear highly blurred with washed out detail when viewed through the white film.

Solutions to that problem could be to use a lensing system or a fibre optic face plate, but in both cases this is expense and bulky and so impractical in most realworld applications.

A unique feature of EL displays is that the light emanating from a switched on segment comes, as far as an observer is concerned, right from the surface of the display. This property can be exploited to provide a thin, low cost , flexible, lightweight display that in the off state appears uniform white until the time when the display is turned on in which case the display becomes visible with acceptable fidelity.

In the situation where the optical depth of the display is thick in comparison to the spatial extent of the on segment the light from the on segment diverges and is strongly scattered by the white layer meaning that the spatial extent of the segment is smeared out and indistinct.

For an EL display of the type discussed above, the optical depth of the display is thin compared to the spatial extent of a segment so there is no opportunity for the light to disperse. If the optical properties of the overlayed film are chosen correctly then the light from the image from the on display will appear shining through the white film with excellent fidelity.

The property of the white layer must be that
1) It is highly scattering;
2) The highly scatter element of the film is thin compared to the spatial extent of the smallest element of the display; and
3) The highly scattering film scatters light essentially uniformly over the visible spectra.

Suitable layers can be constructed by screen printing gloss UV cure varnish mixed 4:1 with white ink printed in one coat on a clear gloss polyester or from two layers of Lee Filters polyester film 220 white frost.

Various embodiments of the invention are now described, though by way of illustration only, with reference to the accompanying diagrammatic Drawings in which:

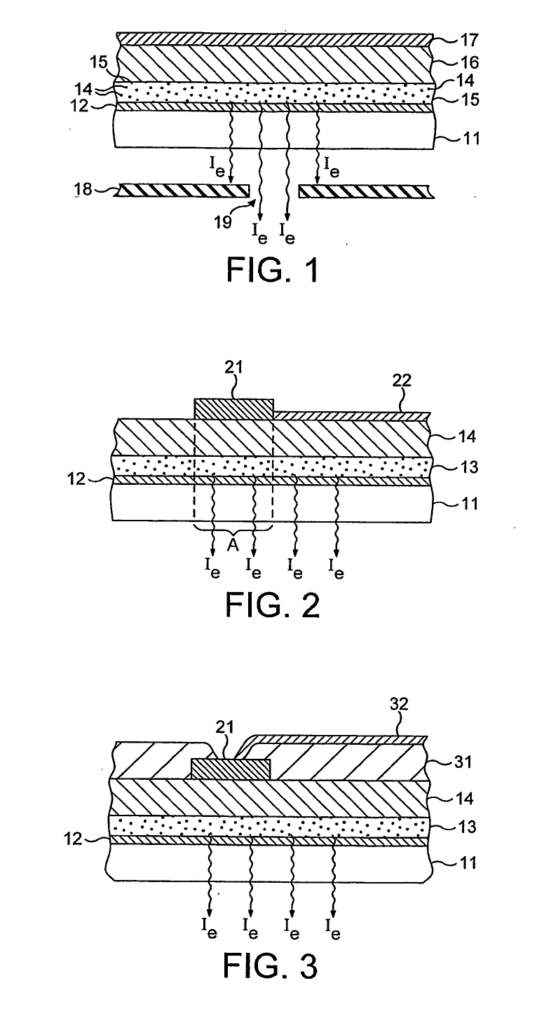

FIG. 1 shows in section a portion of a simplified Prior Art electroluminescent display;

FIG. 2 shows in section a portion of an improved, patterned back electrode, version of the FIG. 1 simplified Prior Art display;

FIG. 3 shows in section a portion of a further improved, spaced track, version of the FIG. 2 simplified Prior Art display;

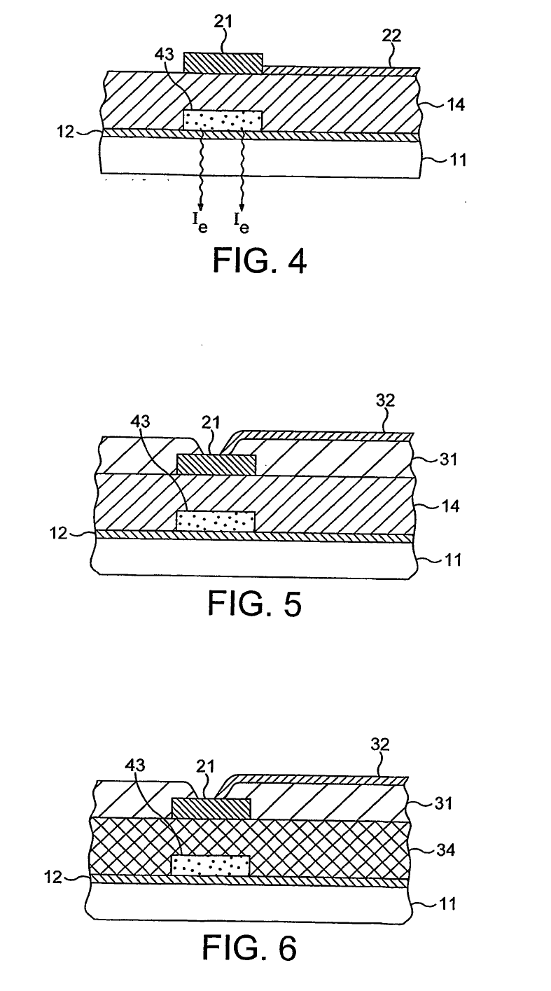

FIG. 4 shows in section a portion of a simplified display similar to that of FIG. 2 but further improved—having a patterned phosphor layer;

FIG. 5 shows in section a portion of an improved simplified display similar to that of FIG. 4 but further improved in the spaced-track manner shown in FIG. 3;

FIG. 6 shows in section a portion of an improved simplified display similar to that of FIG. 5 but yet further improved by “colouring” the ceramic insulator layer in accordance with the invention;

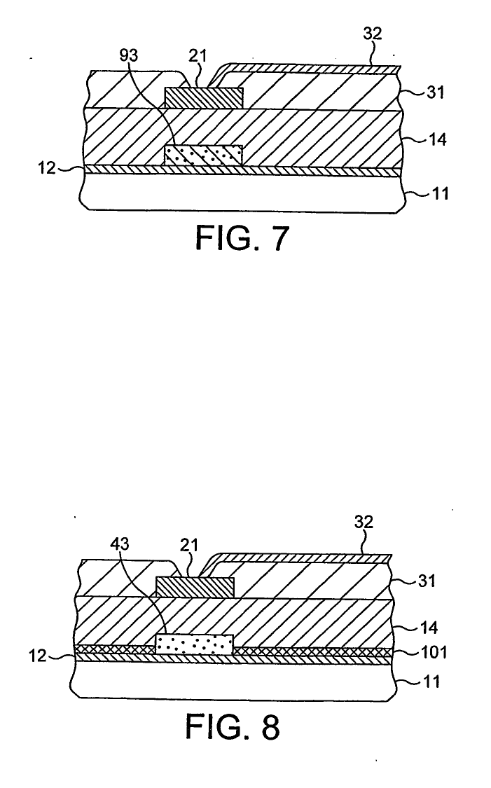

FIG. 7 shows in section a portion of an improved simplified display similar to that of FIG. 5 but alternatively yet further improved by “colouring” the phosphor layer in accordance with the invention;

FIG. 8 shows in section a portion of an improved simplified display similar to that of FIG. 5 but alternatively yet further improved by providing an additional internal layer colour-matching the phosphor layer in accordance with the invention;

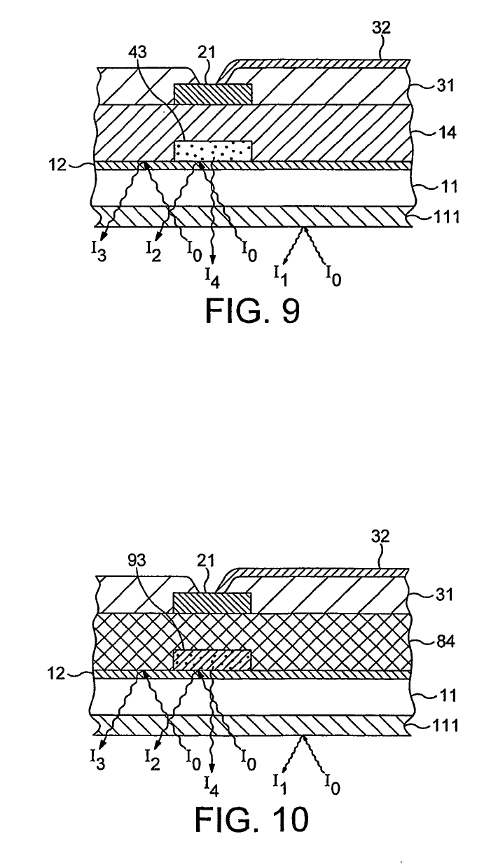

FIG. 9 shows in section a portion of an improved simplified display similar to that of FIG. 5 but alternatively yet further improved by using an external “colouring” layer in accordance with the invention;

FIG. 10 shows in section a portion of an improved simplified display similar to that of FIG. 9 but yet further improved by using, in addition to an external “colouring” layer, coloured phosphor and insulating material layers as well, in accordance with the invention;

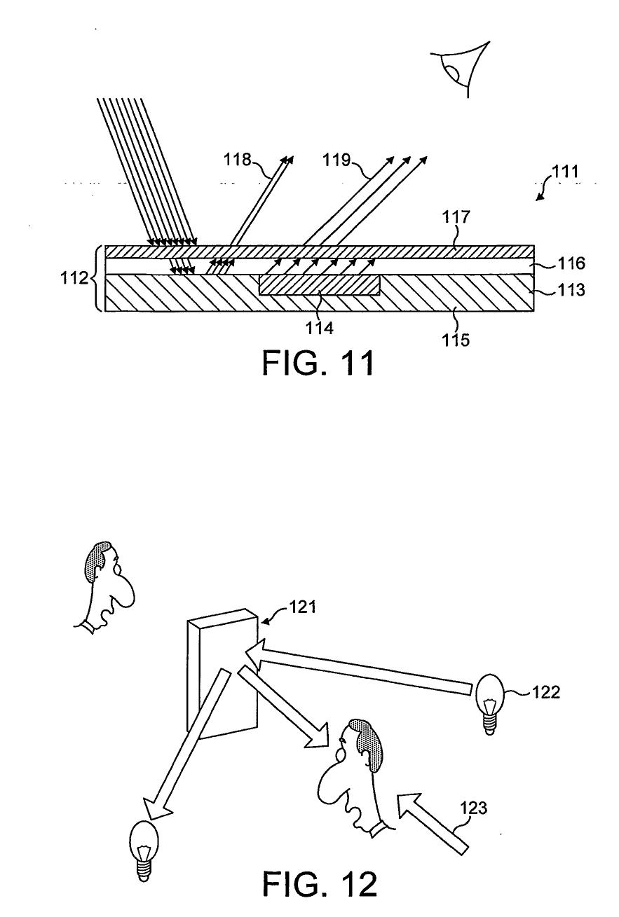

FIG. 11 shows a display having a neutral filter overlay according to the invention; and

FIG. 12 shows a display having a specularly-reflective filter overlay according to the invention.

FIG. 1 shows in section a portion of a simplified Prior Art electroluminescent display. The display is built up on a transparent protective substrate (11) carrying the thin front electrode (12) on which is formed the thicker electroluminescent material (phosphor) layer (13). This phosphor is a granular, particulate, material (as 14) held within a binding matrix (15); the layer itself, however, is here shown as a continuous layer, extending over the entire area of the display.

Behind the phosphor layer 13—on top, as viewed—is a thick layer of an insulating ceramic layer (16), and on that has been formed the back electrode (17). This back electrode is a continuous one, extending, like the phosphor layer 13, over the entire area of the display.

In use an opaque mask (18) is positioned in front of the display—below it, as viewed. By the shaped apertures (as 19) this mask defines the “images” that the display is to show, the light (I₀) emitted by the phosphor being allowed through each aperture 19 but being blocked everywhere else.

FIG. 2 shows in section a similar display portion, with substrate 11, transparent front electrode 12, continuous phosphor layer 13, and ceramic insulator layer 14, but has an image-defining back electrode made up of a number of shaped areas (as 21: only one is here shown) each addressable via thin and narrow lead tracks (as 22). Using a shaped, patterned back electrode 21 means notionally that only those areas (as A) of phosphor directly between the individual shapes 21 and the front electrode 11 are activated, providing illumination I₀. In practice, however, the individual lead tracks 22 also act as back electrodes, so that some small amount of illumination i₀ is also output from the phosphor layer under them, making the display seem confusing. This problem can be at least partly dealt with in the manner shown in FIG. 3, which shows a “spaced-track” version of the FIG. 2 display. As can be seen from FIG. 3, the shaped areas 21 of the back electrode have been surrounded by a thick layer (31) of insulating material, and then the lead tracks 32 to the electrode areas 21 have been formed on top of that. It will be evident that the tracks 32 are spaced considerably further from the phosphor layer 13 in the FIG. 3 embodiment than are the similar tracks 22 in the FIG. 2 embodiment, so that the effect the tracks 32 have is concomitantly smaller, and thus the amount of light (i₀) that they cause to be emitted is also concomitantly smaller, possibly even to the extent of being negligible.

An improved arrangement for avoiding lead track effects is shown in FIG. 4. This shows in section a portion of a simplified display similar to that of FIG. 2 but further improved by being made with a patterned phosphor layer made up of separate individual shapes (43) of phosphor material (43). As will be readily apparent, upon activation the emitted light can only come from the shaped phosphor portions, so there can—in principle—be none emitted because of the field generated by the lead tracks 22. However, in practice it may be that the phosphor and back electrode layers 43 and 21 are not exactly in register with each other, so that some short track portion might overlay a part of the relevant phosphor shape 43, and therefore to minimize any resulting effect of the tracks they are best constructed in the “raised” manner shown in FIG. 3—and this is shown in FIG. 5.

The present invention provides an electroluminescent display in which the colour/reflectivity of one or other of the electroluminescent material and the surrounding insulator material is modified so as to match that of the other. This is shown in FIGS. 6, 7 and 8.

In FIG. 6 is shown one such modified version, wherein the ceramic insulator layer (84) has been coloured to match the colour of the phosphor 43. FIG. 7 shows the case where the phosphor (93) has been coloured to match the ceramic insulator layer 14, and FIG. 8 shows the case where an ink layer (101) has been provided around the shaped area phosphor 43 on the transparent electrode 12, with the ceramic insulator layer 14 over both. The ink layer 101 is coloured to match the phosphor 43.

In FIG. 9 there is shown a slightly different way of reducing the apparent contrast between the shaped area phosphor 43. Over the entire front surface of the substrate 11 there has been formed a coloured filter layer (111). The filter layer 111 modifies how external light (I₀) entering the display is then reflected back from the several interfaces—filter/substrate 111/11, substrate/phosphor 11/43 and substrate/insulator 11/14 (the very thin transparent electrode 12 is here ignored)—such that the light (I₁) reflected off the very front of the display—the front of the filter 111—is very much greater that the light (I₂, I₃) reflected off any of the “internal” interfaces, and that the light I₂ reflected from the substrate/phosphor interface should match in colour and hue the light I₃ reflected from the substrate/insulator interface. And when the display—the phosphor 43—is “on” (activated), the light (I₄) output from the phosphor is significantly greater than any reflected light (and especially that, I₁, off the filter 111 at the very front).

As observed hereinbefore, it will be seen that emitted light I₄ from the phosphor 43 makes one pass through the filter 111 while reflected light I₂, I₃ originating from the ambient surroundings must make two passes through the filter, and so the resultant visibility of any pattern of phosphor 43 is, in the “off” state, reduced by the ratio of the absorbency of the filter. The result is that there is presented the impression of a continuous layer when the combination is viewed.

And if the reflectance spectrum of the filter 111 is shifted in wavelength compared to the filter's transmittance spectrum, so that the colour/hue of the viewed emitted light I₄ from the phosphor 43 is not the same as that of the reflected light I₁ from the very front—the filter—surface of the display, then there is achieved an improvement in visibility through chrominance contrast.

FIG. 10 shows in section a portion of an improved simplified display similar to that of FIG. 9 but yet further improved by using, as well as an external “colouring” layer, coloured phosphor and insulating material layers as well.

The preferred insulating material/dielectric—Dupont 7153—is a broadband reflector with negligible colour hue. Assuming white light is shone on it, it therefore reflects equal amounts of red, green and blue, and when viewed through a blue filter all that can be seen is the blue coloration. A phosphor layer—Dupont 8164, for instance—dyed with a blue such as Stamps Direct's Ink X2 Blue (a commercial version of the blue known generally as “Solvent Blue”), giving it a reflectance spectrum that matches the transmission spectrum of the blue filter (a PVC-based material from Ultramark; 575T134402), also can be seen through the filter as blue. These two observed blues match: the phosphor cannot easily be picked out from the surrounding dielectric.

In this particular blue case it has been found that colouring the dielectric a very pale blue (the same blue that, in a darker form, is used in the filter) and the phosphor a slightly darker shade of the same blue (particularly as the layer of dielectric behind the phosphor makes the phosphor appear to be even darker), improves the effect, making it almost impossible in normal lighting to distinguish the two components. In each case very little blue coloration was added; no more than ten drops blue per 20 ml or so of phosphor or dielectric.

More specifically, a specific instance of the coloration was effected in the following manner:

The normal appearance of the Dupont 8164 phosphor (which emits bright green light) is a bright creamy white, while the normal appearance of the Dupont 7153 dielectric is a strongly-contrasting grey white. First, to reduce this contrast both were coloured with Solvent Blue dye (Stamps Direct's Ink X2 permanent Marking ink)—10 drops in 20 ml of phosphor and 20 drops in 20 ml ceramic dielectric. These concentrations were so low that the cured phosphor was barely tinted, while the cured ceramic was a very pale chalk blue.

Perhaps counter-intuitively, when the pale blue ceramic was added behind the lightly tinted phosphor the apparent contrast of the phosphor was in fact significantly increased compared with an undyed control.

Surprisingly, when a display made using materials coloured in this manner was overlayed with a blue filter (Ultramark 575/T134402) the apparent contrast was reduced to little or nothing; it was hard if not impossible under normal light to distinguish the phosphor from its dielectric surroundings.

In FIG. 11 there is shown part of a display device (generally 111) having a multilayer display (112: only part of this is visible). The display 112 includes a display layer (113), in which is a display element (114: shown in it's “on” state) surrounded by other, structural, material (115), on top of which is a transparent protective layer (116). Overlying this is an outer layer (117) of neutral-density filter material.

Light coming from the display device towards the User—the eye—is a mixture of ambient light (118) and generated light (119); the reflected ambient light 118 is light that has first impinged upon the display from outside, then been transmitted through the filter layer 117, with attenuation, and through the transparent protective layer 116, and has then been reflected off the display material 115 and—with further attenuation—back out through the layers 116 and 117. By comparison, light emanating from the “on” display element 114 has travelled only once (with some attenuation) through the filter layer 117.

It will be apparent that the use of the filter layer 117 has significantly increased the display contrast—the intensity difference between the emitted element light and the reflected ambient light.

FIG. 12 shows the use of a specularly-reflective overlay in accordance with the invention. It shows a display device (generally 121) viewed under strong ambient light. It will be evident that the ambient light (from the source 122 positioned off to one side) is—because of the specular nature of the front surface of the display device—all reflected off to the other side, none of it being directed towards the User. It will also be apparent that any image of the User (caused by him or her being reflected in the reflective layer 122) is, far behind the device, well out of the plane on which he/she focuses to see the display, and so should not be troublesome.

Any light (123) from an ambient source directly behind the User is, of course, blocked by the User's head, and so is not seen.

An example EL lamp using a highly scattering white overlay film is constructed as follows:

The phosphor layer is High Bright Green from Dupont Part No—8164;

The 300 Ohm ITO coated PET is constructed from Bekaert NV-CT-300, Sheldahl 157349 or CPFilms OC300;

The highly scattering white overlay film is either screen printed gloss UV cure varnish mixed 4:1 with white ink printed in one coat on a clear gloss polyester or it is two layers of Lee Filters polyester film 220 white frost.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. An electroluminescent display of the type wherein a layer of electroluminescent material is sandwiched between but spaced from two electrode layers, and the electroluminescent material is composed of a plurality of separate areas each matching in shape and size the image which the relevant portion of the display is to show, each such area being surrounded by a layer of insulating material,
in which the display is provided with a front filter/absorber layer as an overlay or transparent material, arranged so as to modify the manner in which external light entering the display from the ambient surroundings is transmitted thereinto and then reflected back,
in which the filter/absorber layer is a part of a substrate of the display.

45. An electroluminescent display according to claim 44, wherein the substrate supports one of the electrode layers.

46. An electroluminescent display of the type wherein a layer of electroluminescent material is sandwiched between but spaced from two electrode layers, and the electroluminescent material is composed of a plurality of separate areas each matching in shape and size the image which the relevant portion of the display is to show, each such area being surrounded by a layer of insulating material,
in which the display is provided with a front filter/absorber layer as an overlay or transparent material, arranged so as to modify the manner in which external light entering the display from the ambient surroundings is transmitted thereinto and then reflected back,
in which the light reflected from the front of the display is very much greater than the light reflected off any of the internal interfaces.

47. The display of claim 46 in which the front filter/absorber layer is formed from a coloured transparent material.

48. An electroluminescent display of the type wherein a layer of electroluminescent material is sandwiched between but spaced from two electrode layers, and the electroluminescent material is composed of a plurality of separate areas each matching in shape and size the image which the relevant portion of the display is to show, each such area being surrounded by a layer of insulating material,
in which the display is provided with a front filter/absorber layer as an overlay or transparent material, arranged so as to modify the manner in which external light entering the display from the ambient surroundings is transmitted thereinto and then reflected back,
in which the reflectance spectrum of the filter is shifted in wavelength compared to the transmittance spectrum of the filter, so that the colour/hue of the emitted light from the phosphor is not the same as that of the reflected light from the very front surface of the display.

49. The display of claim 48 in which the front filter/absorber layer is formed from a coloured transparent material.

50. An electroluminescent display of the type wherein a layer of electroluminescent material is sandwiched between but spaced from two electrode layers, and the electroluminescent material is composed of a plurality of separate areas each matching in shape and size the image which the relevant portion of the display is to show, each such area being surrounded by a layer of insulating material,
in which the display is provided with a front filter/absorber layer as an overlay or transparent material, arranged so as to modify the manner in which external light entering the display from the ambient surroundings is transmitted thereinto and then reflected back,
in which the front filter/absorber layer is formed from a coloured transparent material, and
in which the front filter/absorber layer has a transmission colour that matches the light emitted by the electroluminescent material when illuminated, and wherein the electroluminescent material and the insulating material are coloured to have the complementary colour to the filter transmission colour.

51. An electroluminescent display of the type wherein a layer of electroluminescent material is sandwiched between but spaced from two electrode layers, and the electroluminescent material is composed of a plurality of separate areas each matching in shape and size the image which the relevant portion of the display is to show, each such area being surrounded by a layer of insulating material,
in which the display is provided with a front filter/absorber layer as an overlay or transparent material, arranged so as to modify the manner in which external light entering the display from the ambient surroundings is transmitted thereinto and then reflected back,
in which the filter/absorber layer has a specularly-reflective front surface.

52. The display of claim 51 in which the specularly-reflective filter/absorber is a multiplayer “radiant” colour film.

53. An electroluminescent display of the type wherein a layer of electroluminescent material is sandwiched between but spaced from two electrode layers, and the electroluminescent material is composed of a plurality of separate areas each matching in shape and size the image which the relevant portion of the display is to show, each such area being surrounded by a layer of insulating material,
in which the display is provided with a front filter/absorber layer is an overlay or transparent material, arranged so as to modify the manner in which external light entering the display from the ambient surroundings is transmitted thereinto and then reflected back,
in which the filter/absorber is a highly scattering white film and wherein the scattering element of the film is thin compared to the spatial extent of the smallest element of the display and the highly scattering film scatters light essentially uniformly over the visible spectra.

54. The display of claim 53 in which the filter/absorber layer is a neutral density filter.

55. An electroluminescent display of the type wherein a layer of electroluminescent material is sandwiched between but spaced from two electrode layers, and the electroluminescent material is composed of a plurality of separate areas each matching in shape and size the image which the relevant portion of the display is to show, each such area being surrounded by a layer of insulating material,
in which the display comprises a thin somewhat transparent metallic electrode.

56. An electroluminescent display of the type wherein a layer of electroluminescent material is sandwiched between but spaced from two electrode layers, and the electroluminescent material is composed of a plurality of separate areas each matching in shape and size the image which the relevant portion of the display is to show, each such area being surrounded by a layer of insulating material,
in which the electroluminescent material comprises phosphor and the phosphor and the insulating material are coloured with a different intensity of the same colour.

57. The display of claim 56, in which the display is provided with a front filter/absorber layer is an overlay or transparent material, arranged so as to modify the manner in which external light entering the display from the ambient surroundings is transmitted thereinto and then reflected back, the filter/absorber layer being formed of a coloured transparent material.

58. The display of claim 57 in which the filter/absorber layer is coloured with a different intensity of the same colour as the phosphor and the insulating material.

59. An electroluminescent display of the type wherein a layer of electroluminescent material is sandwiched between but spaced from two electrode layers, and the electroluminescent material is composed of a plurality of separate areas each matching in shape and size the image which the relevant portion of the display is to show, each such area being surrounded by a layer of insulating material,
in which the display is provided with a front filter/absorber layer is an overlay or transparent material, arranged so as to modify the manner in which external light entering the display from the ambient surroundings is transmitted thereinto and then reflected back,
the filter/absorber layer being formed of a coloured transparent material.
